(19) United States
(12) Patent Application Publication
(10) Pub. No.: US 2012/0093139 A1
(43) Pub. Date: Apr. 19, 2012

(54) Methods, Apparatuses and Computer Program Products

(76) Inventors: Kari Juhani Hooli, Oulu (FI); Kari Pekka Pajukoski, Oulu (FI); Esa Tapani Tiirola, Kempele (FI)

(21) Appl. No.: 13/265,189

(22) PCT Filed: Apr. 20, 2009
(86) PCT No.: PCT/EP09/54642

§ 371 Date: Jan. 5, 2012

(51) Int. Cl. H04W 72/04

(52) U.S. Cl. 370/337

(57) ABSTRACT

There is provided an apparatus including a processor configured to apply space-code block coding to control symbols to be transmitted from at least two transmit antennas; a processor configured to map the space-code block coded control symbols on at least two different physical uplink control channels or cyclic shifts of the same base sequence; and a transmitter configured to transmit the cyclically shifted sequences modulated by the space-code block coded control symbols simultaneously from the at least two transmit antennas.

### FIELD

The invention relates to methods, apparatuses and computer program products for transmission of control symbols.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

There is an ongoing effort to increase data rates in a mobile communication network. One possible solution for achieving high data rates is to use multiple antennas at both or one of a transmitter and a receiver. For example, it is commonly understood that a single user multiple-input multiple-output (SU-MIMO) with two or up to four transmission antennas will be employed in one realization of a Long Term Evolution Advanced (LTE-A). The LTE-A is the next step from LTE and fulfils the requirements of the fourth generation (4G) communication network as specified by the International Telecommunications Union (ITU). The LTE on the other hand is the next step from a universal mobile telecommunications system (UMTS).

LTE-A will be an evolution of LTE release 8 (Rel'8) system fulfilling the ITU-R requirements for IMT-Advanced. One of the assumptions that have been made related to LTE-A evolution is related to backwards compatibility: a Rel'8 E-UTRA terminal must be able to work in an advanced E-UTRAN, and an advanced E-UTRAN terminal can work in a Rel'8 E-UTRAN.

LTE-A applies a physical uplink control channel (PUCCH) to transmit control signals, such as an acknowledgement (ACK)/negative-ACK (NACK), a channel quality indicator (CQI) and a scheduling request (SR) indicator, from user equipment (UE) to an evolved node B (eNB). It is anticipated that, for example, the size of the CQI will increase, for example due to downlink co-operative multipoint (CoMP) transmissions. It is expected that a large CQI can be transmitted on a physical uplink shared channel (PUSCH). However, it is likely that there will also be a need for CQI sizes that are currently too large for Rel'8 PUCCH formats 2/2a/2b and, on the other hand, are too small to be transmitted efficiently on the PUSCH.

One challenge regarding the PUCCH is how to increase the PUCCH format 2/2a/2b payload and/or how to optimize the PUCCH format 2/2a/2b performance while keeping backward compatibility with an LTE Rel'8 terminal and obtaining transmit diversity efficiently at the same time. One solution to increase the PUCCH format 2/2a/2b payload is to allocate multiple PUCCH channels for a single UE. However, this technique does not provide transmit diversity on a symbol level. Further, in the case of the CQI, some transmit divarsity can be obtained via channel coding techniques. Space-time block coding (STBC) can be used with a PUCCH format 2 but it does not increase the payload for the CQI, for example. Additionally, the application of STBC is not straightforward with an odd number of data symbols. Further, it is difficult to apply space-frequency block coding (SFBC) on PUCCH transmission while maintaining backward compatibility with Rel'8 terminals on the same PUCCH resources.

### BRIEF DESCRIPTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise methods, apparatuses, and computer program products as defined in the independent claims. Further embodiments of the invention are disclosed in the dependent claims.

An aspect of the invention relates to an apparatus comprising a processor configured to apply space-code block coding to control symbols to be transmitted from at least two transmit antennas; a processor configured to map the space-code block coded control symbols on at least two different physical uplink control channels or cyclic shifts of the same base sequence; and a transmitter configured to transmit the cyclically shifted sequences modulated by the space-code block coded control symbols simultaneously from the at least two transmit antennas.

A further aspect of the invention relates to an apparatus comprising a processor configured to allocate at least two different physical uplink control channels or cyclic shifts of the same base sequence to a single user device via higher layer signalling; and a receiver configured to receive cyclically shifted sequences modulated by space-code block coded control symbols transmitted simultaneously on at least two physical uplink control channels or cyclic shifts from two or more transmit antennas of a user device comprising at least two transmit antennas.

A still further aspect of the invention relates to a method comprising: applying space-code block coding to control symbols to be transmitted from at least two transmit antennas; mapping the space-code block coded control symbols on at least two different physical uplink control channels or cyclic shifts of the same base sequence; and transmitting the cyclically shifted sequences modulated by the space-code block coded control symbols simultaneously from the at least two transmit antennas.

A still further aspect of the invention relates to a method comprising: allocating at least two different physical uplink control channels or cyclic shifts of the same base sequence to a single user device via higher layer signalling; and receiving cyclically shifted sequences modulated by space-code block coded control symbols transmitted simultaneously on at least two physical up-link control channels or cyclic shifts from two or more transmit antennas of a user device comprising at least two transmit antennas.

A still further aspect of the invention relates to a computer program product, embodied on a computer-readable medium and comprising a program code which, when run on a processor, executes the method comprising: applying space-code block coding to control symbols to be transmitted from at least two transmit antennas; mapping the space-code block coded control symbols on at least two different physical uplink control channels or cyclic shifts of the same base sequence; and transmitting the cyclically shifted sequences modulated by the space-code block coded control symbols simultaneously from the at least two transmit antennas.

A still further aspect of the invention relates to a computer program product, embodied on a computer-readable medium and comprising a program code which, when run on a processor, executes the method comprising: allocating at least two different physical uplink control channels or cyclic shifts of the same base sequence to a single user device via higher layer signalling; and receiving cyclically shifted sequences modulated by space-code block coded control symbols transmitted simultaneously on at least two physical up-link control channels or cyclic shifts from two or more transmit antennas of a user device comprising at least two transmit antennas.

Although the various aspects, embodiments and features of the invention are recited independently, it should be appreciated that all combinations of the various aspects, embodiments and features of the invention are possible and within the scope of the present invention as claimed.

### LIST OF DRAWINGS

In the following the invention will be described in greater detail by means of exemplary embodiments with reference to the attached drawings, in which

FIG. 1 shows a simplified block diagram illustrating an exemplary system architecture;

FIGS. 2A and 2B show block diagrams of apparatuses according to exemplary embodiments of the invention;

FIG. 3 illustrates an exemplary signalling procedure for transmitting control symbols according to an embodiment of the invention;

FIG. 4 shows a block diagram of apparatuses according to an exemplary embodiment of the invention;

FIG. 5 shows an example of a method of transmitting control symbols according to an embodiment of the invention; and

FIG. 6 shows an example of a method for receiving control symbols on the physical uplink control channel according to an embodiment of the invention.

### DESCRIPTION OF EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems that support the required functionality. The protocols used, the specifications of communication systems, servers and user terminals, especially in wireless communication, develop rapidly. Such a development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on Evolved UMTS terrestrial radio access (E-UTRA, UMTS=Universal Mobile Telecommunications System) without restricting the embodiment to such an architecture, however.

Many different radio protocols to be used in communications systems exist. Some examples of different communication systems are the Universal Mobile Telecommunications System (UMTS) radio access network (UTRAN or E-UTRAN), Long Term Evolution (LTE, the same as E-UTRA), Wireless Local Area Network (WLAN), Worldwide Interoperability for Microwave Access (WiMAX), Bluetooth®, Personal Communications Services (PCS) and systems using Ultra Mobile Wideband (UWB) technology.

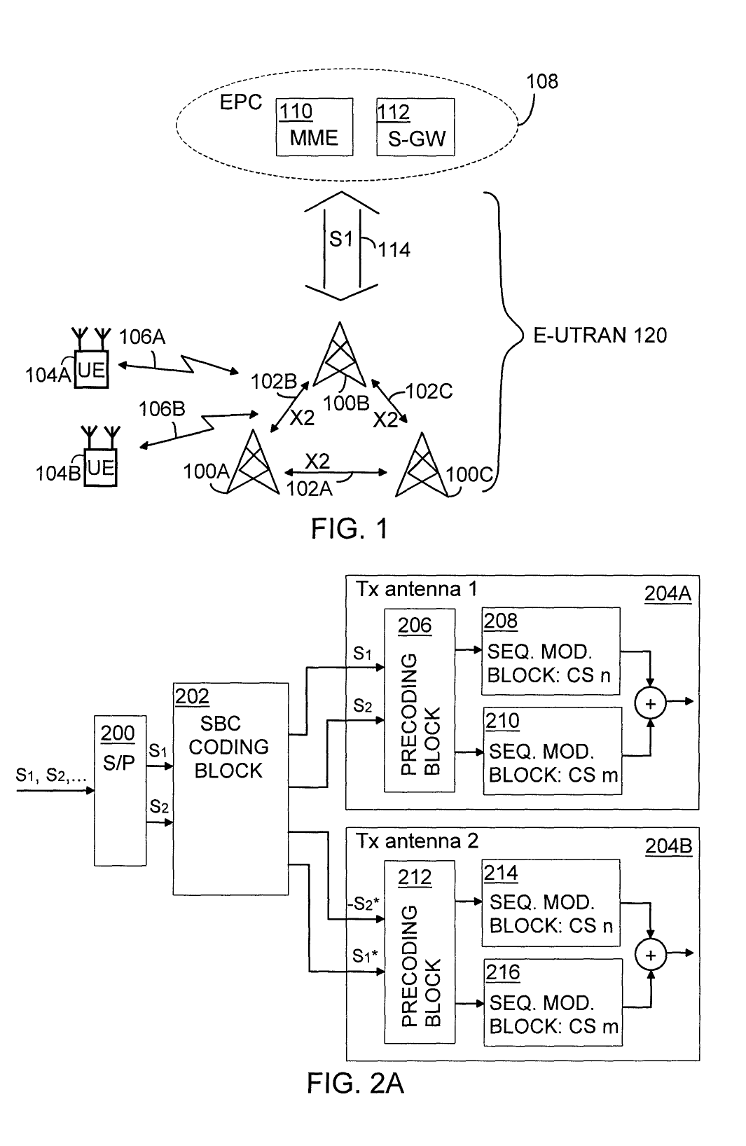

FIG. 1 illustrates a very general network architecture of the LTE in which the embodiments of the invention may be applied. The LTE is based on the release 8th of the standardization work performed by the 3rd Generation Partnership Project (3GPP). FIG. 1 shows only a very general architecture of the LTE network according to an embodiment of the invention. Thus, FIG. 1 shows only the elements and functional entities required for understanding the LTE architecture according to an embodiment of the invention. Other components have been omitted for the sake of simplicity. The implementation of the elements and functional entities may vary from that shown in FIG. 1. The connections shown in FIG. 1 are logical connections, and the actual physical connections may be different. It is apparent to a person skilled in the art that the LTE may also comprise other functions and structures. Although this invention is described using the LTE as a basis, it could be applicable to any other wire-less mobile communication system as well.

The LTE is enhanced with a new radio access technique called evolved UMTS terrestrial radio access network (E-UTRAN) 120. The E-UTRAN 120 consists of central nodes 100A to 100C, such as an evolved node B (eNB), which are interconnected by X2 interfaces 102A to 102C. The central nodes 100A to 100C may be any apparatus capable of handling radio resource management and radio access control within a cell in which the apparatus provides coverage. The apparatus may thus be, for example, an eNB, a base station or a radio network controller (RNC). Therefore, the central nodes 100A to 100C may perform tasks related to resource management, admission control, scheduling and measurements related to the channel quality.

The central nodes 100A to 100C may further interface with user equipments 104A to 104B via radio link connections 106A to 106B. The connections 106A to 106B may be either downlink connections or uplink connections.

Further, the LTE is accommodated with a new packet core architecture called evolved packet core (EPC) 108 network architecture. Each eNB 100A to 100C is further connected to the EPC 108 by an S1 interface 114. The EPC may comprise, for example, a mobility management unit (MME) 110 and a service gateway (S-GW) 112. On a user plane the S1 interface 114 terminates to the S-GW 112, and on a signalling plane the S1 interface 114 terminates to the MME 110. Thus, the S-GW 112 guides and forwards user data packets, whereas the MME 110 handles control signalling related to user mobility. The EPC may comprise also other functionalities besides those related to the MME 110 and the S-GW 112 but for reasons of simplicity they are not depicted in FIG. 1.

The physical layer of the LTE includes orthogonal frequency division multiple access (OFDMA) and multiple-input and multiple-output (MIMO) data transmission. For example, the LTE deploys the OFDMA for the downlink transmission and single carrier frequency division multiple access (SC-FDMA) for the uplink transmission. In the OFDMA, the transmission frequency band is divided into multiple sub-carriers orthogonal to each other. Each sub-carrier may transmit data to a specific UE 104A to 104B. Thus, multiple access is achieved by assigning subsets of sub-carriers to individual UEs 104A to 104B. The SC-FDMA, on the other hand, is a type of discrete Fourier transform (DFT) pre-coded OFDMA scheme. It utilizes single carrier modulation, orthogonal frequency domain multiplexing and frequency domain equalization.

As explained in the background description, the LTE-A is the next step from the LTE and fulfils the requirements of the 4G communication network. The LTE-A provides the physical uplink control channel (PUCCH) as an uplink access link from the UE 104A to 104B to the central node 100A to 100C. The PUCCH may be used to transmit control information to the central node 100A to 100C indicating an acknowledgement (ACK)/a negative-ACK (NACK), a measure of a channel quality and/or a scheduling request (SR). The PUCCH is transmitted on a reserved frequency region in the uplink which is configured by higher layers. PUCCH resource blocks are located at both edges of the uplink bandwidth, and inter-slot hopping is used on the PUCCH. When a UE 104A to 104B has ACK/NACK to send in response to a downlink PDSCH transmission, it will derive the exact PUCCH resource to use from the PDCCH transmission (i.e. the number of the first control channel element used for the transmission of the corresponding downlink resource assignment). When a UE 104A to 104B has a scheduling request or a CQI to send, higher layers will configure the exact PUCCH resource.

The PUCCH carries different uplink control information and it is never transmitted simultaneously with the PUSCH from the same UE. The PUCCH may be divided into different formats. Format 1 is generated for transmitting an unmodulated scheduling request indicator (SRI) indicating a need for the uplink transmission. The need for the uplink transmission may be due to data that has been buffered in the UE 104A, 104B and is waiting to be transmitted in the uplink transmission. Format 1a/1b of the PUCCH is applied in the transmission of an ACK/NACK indicator only indicating the correctness of the received downlink data. The ACK/NACK indicator may consist of one or two bits and it may be transmitted by means of a modulated sequence. The modulation is obtained by means of binary phase shift keying (BPSK) or quadrature phase shift keying (QPSK). Further, the modulated ACK/NACK sequence may be affected by zero-autocorrelation (ZAC) sequences.

Format 2/2a/2b enotes a transmission of a periodic CQI and CQI+ACK/NACK indicator. In PUCCH formats 2, 2a, and 2b, the bits for transmission are first scrambled and QPSK modulated. The resulting symbols can be then multiplied with a cyclically shifted ZAC type of sequence where again the cyclic shift varies between symbols and slots. The PUCCH formats 2, 2a, and 2b carry two reference symbols per slot in case of a normal cyclic prefix. A resource block can be configured to support a mix of PUCCH formats 2/2a/2b and 1/1a/1b, or to support formats 2/2a/2b exclusively. All PUCCH formats use a cyclic shift of a sequence in each symbol. The PUCCH format 2, 2a and 2b transmits periodic CQI (and CQI+ACK/NACK) also by means of modulated CAZAC sequences.

The embodiments of the invention provide a multi-antenna signal handling arrangement at the UE 104A to 104B and at the central node 100A to 100C for format 2, 2a and 2b PUCCH by transmitting control information on the physical uplink control channel from at least two antennas or antenna groups. Further, the embodiments of the invention provide solutions for increasing the PUCCH format 2/2a/2b payload and/or for optimizing the PUCCH format 2/2a/2b performance while keeping backward compatibility with an LTE Rel'8 terminal and obtaining transmit diversity efficiently at the same time.

The PUCCH may be seen, from a single UE's 104A, 104B point of view, as one resource block comprising 12 sub-carriers in a frequency domain and one sub-frame in a time domain. One sub-frame may be of a length of one ms and it may comprise two transmission slots. Different UEs 104A, 1048 may be multiplexed by means of FDM between the resource blocks and code division multiplexing (CDM) within a resource block. The CDM may be achieved by applying cyclic shifts of ZAC sequences to the control information. That is, different UEs 104A, 104B may be accommodated by introducing individual cyclic shifts for each UE 104A, 104B. Different UEs 104A to 104B may also be accommodated by applying block-wise spreading with orthogonal spreading codes to the ZAC affected sequences. The spreading code may be, for example, a Walsh-Hadamard code. This increases the multiplexing capacity by a factor of a spreading factor.

The physical resources used for the PUCCH depend on two parameters, N_{RB}⁽²⁾ and Nₑₛ⁽¹⁾ given by higher layers. The variable N_{RB}⁽²⁾≧0 denotes the bandwidth in terms of resource blocks available for use by PUCCH formats 2/2a/2b transmission in each slot. The variable Nₑₛ⁽¹⁾ denotes the number of cyclic shift used for PUCCH formats 1/1a/1b in a resource block used for a mix of formats 1/1a/1b and 2/2a/2b.

As currently defined in section 5.4.2 of 3GPP TS 36.211, with PUCCH formats 2, 2a and 2b, the block of bits are scrambled with a UE-specific scrambling sequence, resulting in a block of scrambled bits. The block of scrambled bits are modulated resulting in a block of complex-valued modulation symbols d(0), . . . , d(9). Each complex-valued symbol d(0), . . . , d(9) is multiplied with a cyclically shifted length N_{seq}^{PUCCH}=12 sequence r_{u,v}^{(α)}(n) according to:

z(N_{seq}^{PUCCH}·n+i)=d(n)·r_{u,v}^{(α)}(i)

n=0,1, . . . , 9

i=0,1, . . . , Nₛₑ^{RB}−1 (1)

where r_{u,v}^{(α)}(i) is a reference signal sequence defined by a cyclic shift α of a base sequence r̅_{u,v}(n) according to:

r_{u,v}^{(α)}(n)=e^{jαn} r̅_{u,v}(n), 023 n<M_{sc}^{RS} (2)

where M_{sc}^{RS}=mN_{sc}^{RB} is the length of the reference signal sequence and 1≦m≦N_{RB}^{mns,UL}. Multiple reference signal sequences are defined from a single base sequence through different values of α.

Resources used for transmission of PUCCH formats 2/2a/2b are identified by a resource index n_{PUCCH}⁽²⁾ from which the cyclic shift α(nₛ,l) is determined according to:

$$α ( {n}_{s} , l ) = 2 π \cdot {n}_{cs} ( {n}_{s} , l ) / {N}_{sc}^{RB} \\ where \\ {n}_{cs} ( {n}_{s} , l ) = ( {n}_{cs}^{cell} ( {n}_{s} , l ) + {n}^{′} ( {n}_{s} ) ) mod {N}_{SC}^{RB} \\ and \\ {n}^{′} ( {n}_{s} ) = \{ \begin{matrix}{n}_{PUCCH}^{( 2 )} {mod N}_{sc}^{RB} & if {n}_{PUCCH}^{( 2 )} < {N}_{sc}^{RB} {N}_{RB}^{( 2 )} \\ ( {n}_{PUCCH}^{( 2 )} + {N}_{cs}^{( 1 )} + 1 ) mod {N}_{sc}^{RB} & otherwise\end{matrix} \qquad ( 3 )$$

for nₛ mod 2=0 and by

$${n}^{′} ( {n}_{s} ) = \{ \begin{matrix}[ {N}_{sc}^{RB} ( {n}^{′} ( {n}_{s} - 1 ) + 1 ) ] mod ( {N}_{sc}^{RB} + 1 ) - 1 & if {n}_{PUCCH}^{( 2 )} < {N}_{sc}^{RB} {N}_{RB}^{( 2 )} \\ ( {N}_{sc}^{RB} - 2 - {n}_{PUCCH}^{( 2 )} ) mod {N}_{sc}^{RB} & otherwise\end{matrix}$$

for nₛ mod 2=1.

For PUCCH formats 2a and 2b supported for normal cyclic prefix only, the bit(s) b(20), . . . , b(M_{bit}−1) can be modulated as described in Table 1 resulting in a single modulation symbol d(10) used in the generation of the reference signal for PUCCH format 2a and 2b.

TABLE 1
Modulation symbol d(10) for PUCCH formats 2a and 2b

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

The block of complex-valued symbols are multiplied and mapped in sequence to resource elements.

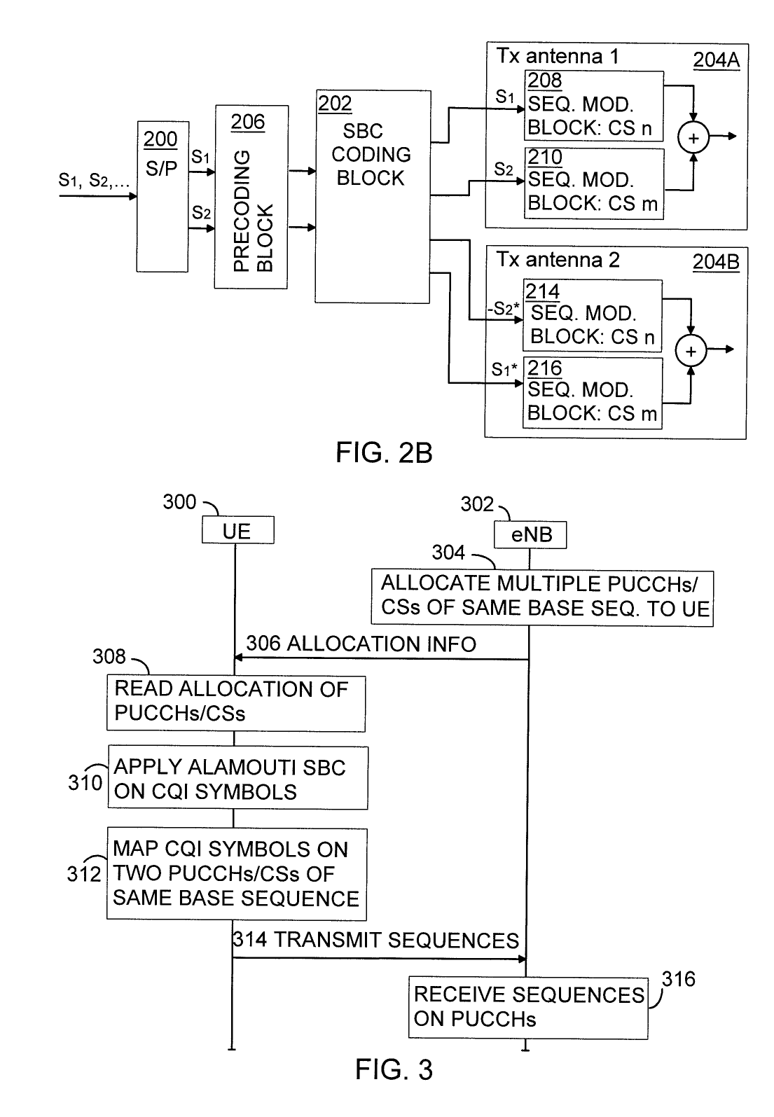

Next, exemplary embodiments of the invention will be described in more detail. FIGS. 2A and 2B show block diagrams of apparatuses according to exemplary embodiments of the invention. More precisely, FIGS. 2A and 2B illustrate transmission schemes according to embodiments where control symbols are to be transmitted on the PUCCH from at least two antennas or antenna groups 204A, 204B of the apparatus. The apparatus may be, for example, a transmitter device that is part of a UE. FIGS. 2A and 2B show only elements and functional entities required for understanding the invention. Other components have been omitted for reasons of simplicity. The implementation of the elements and functional entities may vary from that shown in FIGS. 2A and 2B. It is apparent to a person skilled in the art that the apparatuses of FIGS. 2A and 2B may also comprise other functions and structures.

The apparatus of FIG. 2A comprises a serial-to-parallel conversion block 200 for converting a stream of bits S₁, S₂, . . . relating to the transmitted control symbols into parallel data streams S₁, S₂. The apparatus further comprises a space-code block coding block 202 for applying space-code block coding for the data streams S₁, S₂. Space time block coding (STBC) is a technique used in wireless communications to transmit multiple copies of a data stream across a number of antennas and to exploit the various received versions of the data to improve the reliability of data transfer. An STBC can be illustrated by a matrix. Each row of the matrix represents a time slot and each column represents one antenna's transmissions over time.

An example of an STBC is Alamouti's block coding scheme that is designed for a two-transmit antenna system and has the coding matrix in the following form:

$${C}_{2} = [ \begin{matrix}{s}_{1} & {s}_{2} \\ - {s}_{2}^{*} & {s}_{1}^{*}\end{matrix} ] \qquad ( 4 )$$

where * denotes the complex conjugate, and sᵢⱼ is the modulated symbol to be transmitted in a time slot i from an antenna j. Alamouti's code takes two time slots to transmit two symbols. There exists a perfect orthogonality between the symbols after receive processing. This STBC can achieve a full diversity gain without needing to sacrifice its data rate and it enables full diversity with linear processing at the receiver.

In an embodiment, the space-code block coded control symbols are mapped on at least two different physical uplink control channels or cyclic shifts of the same base sequence and the cyclically shifted sequences modulated by the space-code block coded control symbols are transmitted simultaneously from the at least two transmit antennas 204A, 204B. For that purpose, in the example of FIG. 2A, the space-code block coded data symbols, here bits S₁, S₂, Sᵢ*, −S₂*, are next processed at precoding blocks 206, 212 for multisequence modulation. After modulating and precoding the coded bits, the outputs of the blocks 206 and 212 are input to sequence modulation blocks 208, 210, 214, 216 where the modulated and precoded bit streams are multiplied by mth and nth cyclic shifts of a ZAC code. The modulated signals are then combined and further processed in the transmitter block until the resulting signals are ready to be transmitted simultaneously from at least two of the transmit antennas 204A, 204B.

In an embodiment, when Alamouti's block coding is used, the block coding remains orthogonal if the antenna specific channel remains constant during the transmission of the coding block of two symbols. This is the case if the assigned PUCCH format 2/2a/2b channels are from the same physical resource block.

Multiple PUCCH format 2/2a/2b channels can be assigned to a single UE via higher layer signalling with a minor change to the current Rel'8 signalling. Since the assignment is persistent, it is straightforward according to an embodiment to assign multiple PUCCH format 2/2a/2b channels to an UE from the same physical resource block.

According to an embodiment, two PUCCH format 2/2a/2b channels or cyclic shifts are transmitted simultaneously from a single antenna. This increases the transmission cubic metric. However, according to an embodiment, the cubic metric increase can be alleviated by using multi-sequence modulation precoding per antenna. In an embodiment, optimization of cubic metric properties for precoded multi-sequence modulation requires assignment of cyclic shift pairs with a certain preferred cyclic shift offset for the same UE. It should be noted that, for example, the Rel'8 PUCCH format 2/2a/2b resource remapping on a slot boundary maintains the cyclic shift offset between two PUCCH channels constant, essentially reversing the PUCCH channel mapping to the cyclic shifts. Thus, the existing resource remapping works well with the multi-sequence modulation precoding according to an embodiment.

The apparatus of FIG. 2B differs from the apparatus shown in FIG. 2A in that it only comprises one precoding block 206 before the space-code block coding block 202. The apparatus of FIG. 2B also comprises a serial-to-parallel conversion block 200 for converting a stream of bits S₁, S₂, . . . relating to the transmitted control symbols into parallel data streams S₁, S₂. Here, the parallel data streams S₁, S₂ from the serial-to-parallel conversion block 200 are next processed at the precoding block 206 for multi-sequence modulation. After modulation and precoding, the bit streams are processed in the space-code block coding block 202. The space-code block coded data symbols, here bits S₁, S₂, S₁*, −S₂*, are then input to sequence modulation blocks 208, 210, 214, 216.

The apparatus shown in FIG. 2B can be applied in an embodiment where the multi-sequence modulation used for precoding comprises: inputting a plurality of bits for precoding the plurality of bits, modulating the precoded plurality of bits using multi-codes comprised of a plurality of cyclic shifts of a ZAC code sequence, and transmitting the modulated precoded plurality of bits, where precoding is performed to reduce a peak to average ratio of a transmitted signal. In an embodiment, the precoding comprises modulating and DFT spreading, where a size of an input and an output of a DFT spreader equals the number of codes of the multi-code. In an embodiment, the precoding comprises the use of a table to directly map the plurality of bits to inphase and quadrature values for each of the multi-codes. An example of such a table is presented below in the context of Table 2. In an embodiment, a separation between the ZAC sequence cyclic shifts is N/m, where N is the sequence length and m is the number of multi codes. In an embodiment, adjacent cyclic shifts of a ZAC sequence are allocated for different multi-codes.

In an embodiment, the transmitting comprises applying in sequence to the modulated precoded plurality of bits at least a sub-carrier mapping operation, an IFFT operation, and a CP insertion operation.

In an embodiment, the transmission scheme requires two orthogonal reference signals. These can be obtained by transmitting one of the assigned reference signal cyclic shifts from each antenna, i.e. with a conventional method.

In an embodiment, in the case of UE with more than two transmit antennas, antenna virtualization or antenna groups can be formed for example with precoding vector switching between grouped antennas on a slot boundary or with cyclic delay diversity (CDD).

In an embodiment, for open loop transmit diversity of control symbol reporting, multiple control symbol resources are allocated for the given UE, and different antennas utilize different control symbol resources (e.g. assuming the eNB signals j=4 and also j=5, the UE's first antennas utilizes the fourth control symbol channel, and the UE's second antenna utilizes the fifth control symbol channel). Here, the radio resources on which control symbols are signalled are indicated as the jth control symbol channel having cyclic shifts CS given by CSindex. The value of the control symbol channel index is explicitly signalled via higher layers (eNB or higher). In an embodiment, the eNB signals only one value for j and different ones of the UE antennas utilize consecutive control symbol resources, starting from the allocated control symbol resource (e.g. the eNB signals j=4, the UE's first antenna uses the fourth control symbol channel and the UE's second antenna uses the fifth control symbol channel). In another embodiment for CQI, the eNB signals only one value for j and different ones of the UE antennas utilize consecutive cyclic shift resources as CQI resources, starting from the allocated cyclic shift resource (e.g. the eNB signals j=4, the UE's first antenna uses the fourth CQI channel with a cyclic shift index 6 and the UE's second antenna uses the fourth CQI channel with a cyclic shift index 7). These teachings are readily extended to more than two UE transmit antennas.

In an embodiment, also higher order space-time block codes can be used for applying space-code block coding for the control symbols when more than two antennas are used for transmission.

In an embodiment, at least two different physical uplink channels comprise physical uplink control channel format 1, 1a or 1b channels.

In an embodiment, the at least two physical uplink control channels or cyclic shifts comprise physical uplink control channel format 2, 2a or 2b channels.

In an embodiment, the space-code block coded control symbols are multiplied with at least two sequences each being formed of different cyclic shifts of the same sequence.

In an embodiment, the space-code block coding is formed according to Table 2 presentation on cyclic shift values related to data bits in the case of two transmit antennas (TX1, TX2):

TABLE 2
Orthogonal cyclic shift selection transmitter diversity

| | Transmitter TX1 | | Transmitter TX2 | |
|---|---|---|---|---|
| Data bits | CyclicShift#1 | CyclicShift#2 | CyclicShift#1 | CyclicShift#2 |
| 000 | 0.707 + j0.707 | 0 | 0 | 0.707 − j0.707 |
| 001 | 0.707 − j0.707 | 0 | 0 | 0.707 + j0.707 |
| 010 | −0.707 + j0.707 | 0 | 0 | −0.707 − j0.707 |
| 011 | −0.707 − j0.707 | 0 | 0 | −0.707 + j0.707 |
| 100 | 0 | 0.707 + j0.707 | 0.707 − j0.707 | 0 |
| 101 | 0 | 0.707 − j0.707 | 0.707 + j0.707 | 0 |
| 110 | 0 | −0.707 + j0.707 | −0.707 − j0.707 | 0 |
| 111 | 0 | −0.707 − j0.707 | −0.707 + j0.707 | 0 |

As can be seen from Table 2, the transmitter antenna TX1 is orthogonal to the second transmitter antenna TX2, since the values of the first cyclic shift CS#1 from the transmitter antenna TX1 relating to the data bits 000 to 011 are complex conjugates of the values of the second cyclic shift CS #2 from the transmitter antenna TX2, respectively. Further, the values of the second cyclic shift CS #2 from the transmitter antenna TX1 relating to the data bits 100 to 111 are complex conjugates of the values of the first cyclic shift CS #1 from the transmitter antenna TX2, respectively. Further, it can be seen that each of the transmitting antennas (TX1, TX2) transmits by using only one channel or cyclic shift at a time.

FIG. 3 illustrates a signalling procedure for transmitting control symbols from a UE 300 to the eNB 302 according to an embodiment of the invention. The UE 300 recognizes a need to report control information about mobile radio channel to the eNB 302. Different reporting modes and formats can be used depending to MIMO mode of operation and the network choice. A lot of different reporting modes and formats are available which are selected according to the MIMO mode of operation and the network choice. The reporting control information may comprise e.g. CQI (channel quality indicator) that is an indication of the downlink mobile radio channel quality as experienced by the UE 300. The UE 300 proposes an optimum modulation scheme and coding rate to use for a given radio link quality to the eNB 302. 16 combinations of a modulation scheme and a coding rate are specified as possible CQI values. The UE 300 may report different types of CQI.

According to an embodiment, the UE 300 is equipped with at least two transmit antenna elements. Thus, it is possible that the UE 300 transmits control information on the PUCCH from multiple antenna groups with spatial transmit diversity. The UE 300 may assign the antenna elements into antenna groups, each antenna group comprising one or more antenna elements.

In 304, the eNB allocates at least two different PUCCH channels or cyclic shifts of the same base sequence to the UE 300 via higher layer signalling. In 306, the allocation information is transmitted from the eNB 302 to the UE 300.

In 308, the UE 300 reads the allocation information about the PUCCH channels/cyclic shifts. In 310, the UE 300 applies space-code block coding to control symbols to be transmitted from the at least two transmit antennas of the UE 300.

In 312, the space-code block coded control symbols are mapped by the UE 300 on at least two different PUCCH channels or cyclic shifts of the same base sequence.

In 314, the cyclically shifted sequences modulated by the space-code coded control symbols are transmitted simultaneously from two or more of the at least two transmit antennas to the eNB 302.

Finally, in 316, the eNB 302 receives the cyclically shifted sequences modulated by the space-code block coded control symbols transmitted simultaneously on the at least two PUCCH channels or cyclic shifts from two or more transmit antennas of the UE 300. The eNB 302 may perform a separate channel estimation by applying different orthogonal codes for the control symbols (the CQI in this case) received from different resources of the PUCCH. The estimations and combinations may be performed separately for each received time slot. The combination of the different control symbols may be based on arithmetic operations, such as summing and/or averaging, performed on the separate channel estimates for the control symbols received from different transmission channels.

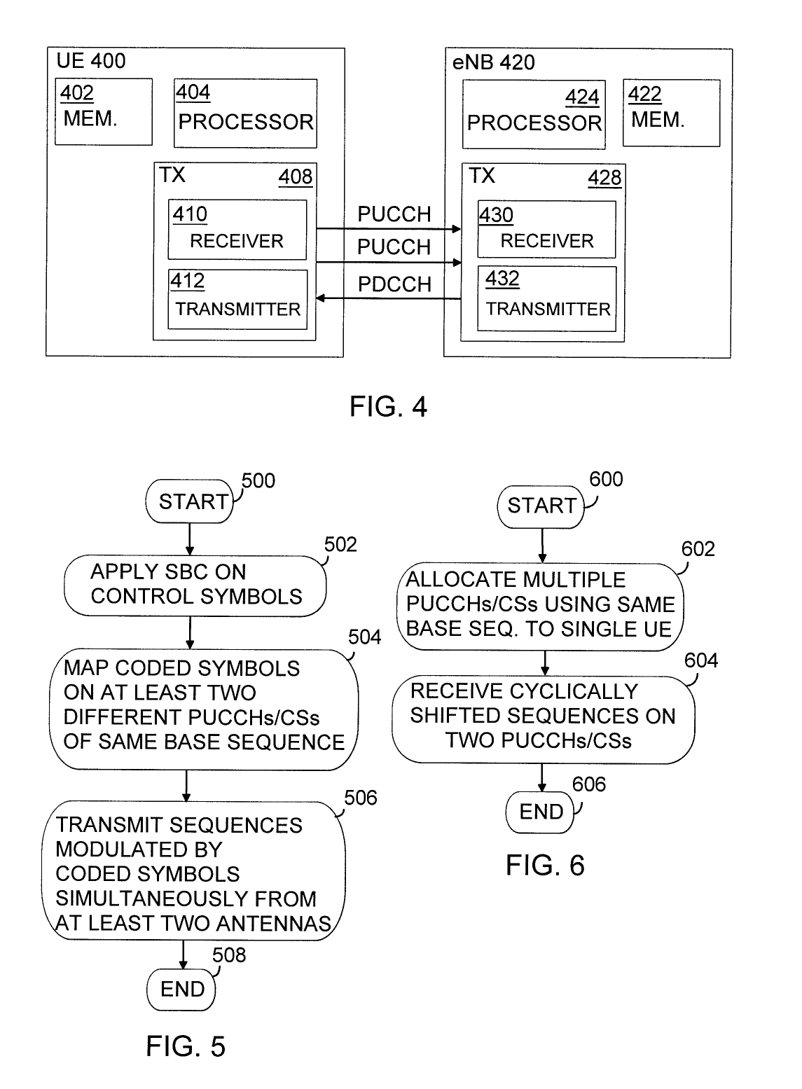

FIG. 4 shows a block diagram of apparatuses according to an embodiment of the invention. The apparatuses may be, for example, a UE 400 and an eNB 420. FIG. 4 shows only the elements and functional entities required for understanding the architectures of the UE 400 and the eNB 420 according to an embodiment of the invention. Other components have been omitted for reasons of simplicity. The implementation of the elements and functional entities may vary from that shown in FIG. 4. The connections shown in FIG. 4 are logical connections, and the actual physical connections may be different. It is apparent to a person skilled in the art that the UE 400 and the eNB 420 may also comprise other functions and structures.

The UE 400 of FIG. 4 comprises an interface 408 comprising a receiver 410 and a transmitter 412 for enabling a physical channel connection via at least two antennas of the UE 400 when needed. The interface 408 may transmit control information on at least two different PUCCH channels. In an embodiment, the transmitter 412 is configured to transmit cyclically shifted sequences modulated by space-code block coded control symbols simultaneously from the at least two transmit antennas of the UE 400.

The UE 400 also comprises a processor 404. The processor 404 decides which control information to send on which resources. The processor 404 may read channel allocation information received from the eNB 420. In an embodiment, the processor 404 applies space-code block coding to control symbols to be transmitted from at least two transmit antennas of the UE 400, and maps the space-code block coded control symbols on at least two different physical uplink control channels or cyclic shifts of the same base sequence. The UE 400 may also comprise a memory 402 comprising volatile and/or non-volatile memory, and it typically stores content, data, or the like. For example, the memory may store computer program code such as software applications or operating systems, information, data, content, or the like for the processor 404 to perform steps associated with the operation of the apparatus in accordance with embodiments. In the illustrated embodiment, the memory stores instructions on how to apply space-code block coding to control symbols to be transmitted and how to map the space-code block coded control symbols on the PUCCHs or cyclic shifts. The memory may be, for example, random access memory (RAM), a hard drive, or other fixed data memory or storage device. Further, the memory, or part of it, may be removable memory detachably connected to the apparatus.

The eNB 420 of FIG. 4 comprises an interface 428 comprising a receiver 430 and a transmitter 432. The interface 428 may perform signal-processing operations for enabling a physical channel connection via one or more antennas. The interface 428 receives control information on one or more resources of PUCCHs associated with a transmitter. The one or more resources may be received from multiple transmission channels, and two or more transmit antennas of the transmitter may transmit simultaneously cyclically shifted sequences modulated by the space-code block coded control symbols on at least two PUCCHs or cyclic shifts.

The eNB 420 may also comprise a processor 424. In an embodiment, the processor 424 determines whether to allocate multiple different physical uplink control channels or cyclic shifts of the same base sequence to a single user device via higher layer signalling. The processor 424 may further determine whether specific resources of the PUCCH are occupied with control information. The eNB 420 may further comprise a memory 422.

The processors 404 and 424 of FIG. 4 may be implemented with separate digital signal processors provided with suitable software embedded on a computer readable medium, or with separate logic circuits, such as application specific integrated circuits (ASIC). The processors may comprise interfaces such as computer ports for providing communication capabilities.

The techniques described herein may be implemented by various means so that an apparatus implementing one or more functions described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For firmware or software, implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer, or external to the processor/computer, in which case it can be communicatively coupled to the processor/computer via various means, as is known in the art.

The programming, such as executable code or instructions (e.g. software or firmware), electronic data, databases, or other digital information, can be stored into memories and it may include processor-usable media. Processor-usable media may be embodied in any computer program product or article of manufacture which can contain, store, or maintain programming, data or digital information for use by or in connection with an instruction execution system including the processor 404, 424 in the exemplary embodiment. For example, exemplary processor-usable media may include any one of physical media, such as electronic, magnetic, optical, electromagnetic, and infrared or semiconductor media. Some more specific examples of processor-usable media include, but are not limited to, a portable magnetic computer diskette, such as a floppy diskette, zip disk, hard drive, random-access memory, read only memory, flash memory, cache memory, or other configurations capable of storing programming, data, or other digital information.

At least some embodiments or aspects described herein may be implemented using programming stored within an appropriate memory described above, or communicated via a network or other transmission media and configured to control an appropriate processor. For example, programming may be provided via appropriate media including, for example, embodied within articles of manufacture, embodied within a data signal (e.g. modulated carrier wave, data packets, digital representations etc.) communicated via an appropriate transmission medium, such as a communication network (e.g. the Internet or a private network), wired electrical connection, optical connection or electromagnetic energy, for example, via communications interface, or it may be provided using another appropriate communication structure or medium. Exemplary programming including processor-usable code may be communicated as a data signal embodied in a carrier wave.

In an embodiment, there is provided a computer program product, embodied on a computer-readable medium and comprising a program code which, when run on a processor, executes the method comprising: applying space-code block coding to control symbols to be transmitted from at least two transmit antennas; mapping the space-code block coded control symbols on at least two different physical uplink control channels or cyclic shifts of the same base sequence; and transmitting the cyclically shifted sequences modulated by the space-code block coded control symbols simultaneously from the at least two transmit antennas.

In another embodiment, there is provided a computer program product, embodied on a computer-readable medium and comprising a program code which, when run on a processor, executes the method comprising: allocating at least two different physical uplink control channels or cyclic shifts of the same base sequence to a single user device via higher layer signalling; and receiving cyclically shifted sequences modulated by space-code block coded control symbols transmitted simultaneously on at least two physical uplink control channels or cyclic shifts from two or more transmit antennas of a user device comprising at least two transmit antennas.

FIG. 5 illustrates a method for transmitting control symbols with at least two antennas. The method begins in 500. In 502, space-code block coding is applied on control symbols to be transmitted from at least two transmit antennas. In 504, the space-code block coded control symbols are mapped on at least two different physical uplink control channels or cyclic shifts of the same base sequence. In 506, the cyclically shifted sequences modulated by the space-code block coded control symbols are transmitted simultaneously from the at least two transmit antennas. The method ends in 508.

FIG. 6 illustrates a method for receiving control information on a physical uplink control channel. The method begins in 600. In 602, at least two different physical uplink control channels or cyclic shifts of the same base sequence are allocated to a single user device via higher layer signalling. In 604, cyclically shifted sequences modulated by space-code block coded control symbols transmitted simultaneously on at least two physical uplink control channels or cyclic shifts from two or more transmit antennas of a user device comprising at least two transmit antennas are received. The method ends in 606.

The steps/points, signalling messages and related functions described above in FIGS. 3, 5 and 6 are in no absolute chronological order, and some of the steps/points may be performed simultaneously or in an order differing from the given one. Other functions can also be executed between the steps/points or within the steps/points and other signalling messages sent between the illustrated messages. Some of the steps/points or part of the steps/points can also be left out or replaced by a corresponding step/point or part of the step/point. The server operations illustrate a procedure that may be implemented in one or more physical or logical entities. The signalling messages are only exemplary and may even comprise several separate messages for transmitting the same information. In addition, the messages may also contain other information.

When compared to some known solutions for increasing PUCCH CQI payload, an embodiment of the invention provides symbol-level transmit antenna diversity, thus, enhancing the performance further. Space-time block coding applied on a single PUCCH format 2/2a/2b channel provides symbol-level transmit antenna diversity. When compared to that, an advantage of an embodiment of the invention is the increased payload obtained with the use of multiple PUCCH channels. Alternatively, the increased symbol space can be used to lower the effective coding rate e.g. for the Rel'8 CQI. This improves PUCCH format 2/2a/2b coverage. Further, space-time block coding suffers from the problem of an unpaired number of symbols. In an embodiment of the invention, the space-code block code used is Alamouti's block coding which is limited within a single SC-FDMA symbol. Thus, no problem due to an odd number of SC-FDMA symbols exists. In an embodiment, the Alamouti's block coded symbols are transmitted at the same time and at the same frequency. Thus, this embodiment differs clearly from space-time block coding and space-frequency block coding.

It will be obvious to a person skilled in the art that, as the technology advances, the inventive concept can be implemented in various ways. The invention and its embodiments are not limited to the examples described above but may vary within the scope of the claims.

1. An apparatus comprising:
a processor configured to apply space-code block coding to control symbols to be transmitted from at least two transmit antennas;
a processor configured to map the space-code block coded control symbols on at least two different physical uplink control channels or cyclic shifts of the same base sequence; and
a transmitter configured to transmit the cyclically shifted sequences modulated by the space-code block coded control symbols simultaneously from the at least two transmit antennas.

2. The apparatus of claim 1, wherein at least two different physical uplink channels comprise physical uplink control channel format 1, 1a or 1b channels.

3. The apparatus of claim 1, wherein the applied space-code block coding applies Alamouti's block coding.

4. The apparatus of claim 1, wherein the at least two physical uplink control channels or cyclic shifts comprise physical uplink control channel format 2, 2a or 2b channels.

5. The apparatus of claim 1, wherein the processor is configured to multiply the space-code block coded control symbols with at least two sequences each being formed of different cyclic shifts of the same sequence.

6. The apparatus of claim 1, wherein the transmitter is further configured to transmit at least two orthogonal reference signals from antennas of a user device by transmitting one of the assigned reference signal cyclic shifts from each antenna.

7. The apparatus of claim 1, wherein the processor is further configured to form antenna virtualization or antenna groups by using precoding vector switching between grouped antennas on a slot boundary or by using cyclic delay diversity when more than two transmit antennas are used.

8. The apparatus of claim 1, wherein the transmitter is configured to use multi-code precoding per antenna for decreasing the transmission cubic metric, and to assign cyclic shift pairs with a predetermined cyclic shift offset in the multi-code precoding.

9. The apparatus of claim 1, wherein the processor is further configured to form the control symbols by using a table to directly map plurality of data bits to inphase and quadrature values for each of the multicodes, and the transmitter is configured to transmit by using one channel of cyclic shift at a time per each transmitting antenna.

10. An apparatus comprising:
a processor configured to allocate at least two different physical uplink control channels or cyclic shifts of the same base sequence to a single user device via higher layer signalling; and
a receiver configured to receive cyclically shifted sequences modulated by space-code block coded control symbols transmitted simultaneously on at least two physical uplink control channels or cyclic shifts from two or more transmit antennas of a user device comprising at least two transmit antennas.

11. The apparatus of claim 10, wherein the allocated at least two physical uplink control channels or cyclic shifts comprise physical uplink control channel format 1, 1a, 1b, 2, 2a or 2b channels.

12. A method comprising:
applying space-code block coding to control symbols to be transmitted from at least two transmit antennas;
mapping the space-code block coded control symbols on at least two different physical uplink control channels or cyclic shifts of the same base sequence; and
transmitting the cyclically shifted sequences modulated by the space-code block coded control symbols simultaneously from the at least two transmit antennas.

13. The method of claim 12, further comprising applying Alamouti's block coding to the control symbols.

14. The method of claim 12, further comprising multiplying the space-code block coded control symbols with at least two sequences each being formed of different cyclic shifts of the same sequence.

15. The method of claim 12, further comprising transmitting at least two orthogonal reference signals from antennas of a user device by transmitting one of the assigned reference signal cyclic shifts from each antenna.

16. The method of claim 12, further comprising forming antenna virtualization or antenna groups by using precoding vector switching between grouped antennas on a slot boundary or by using cyclic delay diversity when more than two transmit antennas are used.

17. The method of claim 12, further comprising using multi-code precoding per antenna for decreasing the transmission cubic metric, and assigning cyclic shift pairs with a predetermined cyclic shift offset in the multi-code precoding.

18. The method of claim 12, further comprising forming the control symbols by using a table to directly map plurality of data bits to inphase and quadrature values for each of the multicodes and transmitting by using one channel of cyclic shift at a time per each transmitting antenna.

19. A method comprising:
allocating at least two different physical uplink control channels or cyclic shifts of the same base sequence to a single user device via higher layer signalling; and
receiving cyclically shifted sequences modulated by space-code block coded control symbols transmitted simultaneously on at least two physical uplink control channels or cyclic shifts from two or more transmit antennas of a user device comprising at least two transmit antennas.

20. A computer program product, embodied on a computer-readable medium and comprising a program code which, when run on a processor, executes the method comprising:
applying space-code block coding to control symbols to be transmitted from at least two transmit antennas;
mapping the space-code block coded control symbols on at least two different physical uplink control channels or cyclic shifts of the same base sequence; and
transmitting the cyclically shifted sequences modulated by the space-code block coded control symbols simultaneously from the at least two transmit antennas.

21. The computer program product of claim 20, further comprising multiplying the space-code block coded control symbols with at least two sequences each being formed of different cyclic shifts of the same sequence.

22. A computer program product, embodied on a computer-readable medium and comprising a program code which, when run on a processor, executes the method comprising:
allocating at least two different physical uplink control channels or cyclic shifts of the same base sequence to a single user device via higher layer signalling; and
receiving cyclically shifted sequences modulated by space-code block coded control symbols transmitted simultaneously on at least two physical uplink control channels or cyclic shifts from two or more transmit antennas of a user device comprising at least two transmit antennas.
